(19) United States
(12) Patent Application Publication
(10) Pub. No.: US 2009/0248469 A1
(43) Pub. Date: Oct. 1, 2009

(54) METHOD AND SYSTEM OF INTEGRATED MINE PLANNING

(75) Inventors: Patrick Gerard Williams, Paddington (AU); Benjamin Axford, Thornside (AU); Geoffrey John Steffens, Eight Mile Plains (AU)

Correspondence Address: Workman Nydegger;1000 Eagle Gate Tower, 60 East South Temple, Salt Lake City, UT, 84111, US

(73) Assignee: Runge Ltd., Brisbane, Queensland (AU)

(21) Appl. No.: 11/995,474

(22) PCT Filed: Aug. 7, 2006
(86) PCT No.: PCT/AU06/01120

§ 371 Date: Jun. 5, 2008

(30) Foreign Application Priority Data
Aug. 9, 2005 (AU) 2005904276

(51) Int. Cl. G06Q 10/00; G06Q 50/00; G06F 21/00

(52) U.S. Cl. 705/8; 705/7; 726/17

(57) ABSTRACT

A system and method for facilitating integrated mine planning in a mining operation. The system has a data module to store data objects. The system also has a management module in communication with the data module and the management module is configured with at least one workflow having a series of interdependent processing steps representative of planning steps for a mine plan. The management module controls the accessibility of one or more users to each of the steps within the at least one workflow. The at least one user is able to obtain one or more data objects from the data store, under the control of the management module, to process the one or more data objects to perform at least one processing step in the at least one workflow using a proprietary expert software solution.

### FIELD OF THE INVENTION

The invention relates to a system and method of mine planning. In particular, although not exclusively, the invention relates to a method and system of integrated mine planning that is adaptive to the dynamic nature of the mining business.

### BACKGROUND TO THE INVENTION

The use of Enterprise Resource Planning (ERP) systems in business is wide spread. ERP is a term for a broad set of activities supported by multi-module application software that helps manufacturers and other forms of business to manage each phase of the business cycle including product planning, parts purchasing, maintaining inventories, interacting with suppliers, providing customer service and tracking orders.

Additionally, ERP systems can also include application modules for the finance and human resources aspects of a business. As such, ERP systems comprise a number of business module orientated sub-parts that are designed to work seamlessly with the rest of the system and provide all users with a consistent interface.

Whilst the use of ERP systems within business's with predictable supply inputs such as manufacturing and supply chain management has been successful, mining operations have inherently unique characteristics that result in the unsuitability of planning components of ERP systems designed for other industries to be deployed within a mining operation.

Mining operations have a high degree of dynamic variability in their primary input, being data in relation to an ore body. As such, detailed mine plans are developed over differing time frames in order to provide guidance and direction for the various mining activities. Furthermore, there is a significant capital investment in setting up a new mine coupled with large operating expenditure during the life of the mine. As such, it is vital that accurate mine plans are continuously developed and implemented throughout the life of a mine in order to maximise return on investment.

As previously mentioned, unlike other industries such as manufacturing and supply chain type industries, planning in a mining operation must cater for a unique set of dynamic variables throughout the life of the mine that has, to date, negated the successful deployment of operation wide ERP systems.

Ore bodies are three dimensional and non-homogenous in nature and the characteristics of the whole ore body are never accurately known at the start of the mining process. During the mine life more detail is discovered as to the geometry, grade and characteristics of the ore body which result in a need to alter the mine plan, thus affecting the return of the operation.

Furthermore, the final product delivered to customers often needs to be a combination of blended products, possibly sourced from different locations within the ore body and/or different ore bodies being mined within the mine. These customer requirements often change over the life of the mine and this change in the characteristics of the mining deliverable must be accounted for when revising the planning for the mining operation.

The time frame of reference is a further factor unique to the mining process. Generally mining operations have long, medium and short term plans, each of which have specific purposes and goals.

The long term mining plan justifies the large capital expenditure required to commit to a new mining operation and provides a series of expectations and deliverables over the life of the mine.

The medium term plan is based upon the deliverables provided by the long term plan and focuses on the details required to achieve these deliverables, including operating budgets for business units within the operation.

The short term plan is focused on deployment of the mining task to provide the expected deliverables utilising the budgeted personnel and equipment.

For example, whilst equipment utilisation is readily estimated for budget purposes, the short term plan must cater for deviations from estimated equipment utilisation and personnel availability. These short term deviations can affect the medium and long term plans. Another common occurrence during the mining process is the presence of an unexpected geological structure such as a fault or the like. The presence of this structure may result in additional personnel or unbudgeted resources being required to overcome this unplanned occurrence and hence the short term, medium term and long term plan needs to be adjusted accordingly.

As discussed, the planning process in the mining industry is non-linear and dynamic. All of the above must be dynamically catered for during the mine planning process in order that business plans can dynamically reflect the current state of the mining process and the expected return. As previously mentioned, due to the unique characteristics of the business of mining, ERP packages that are successfully deployed in other industries have limited success in the mining industry with regard to the planning function.

Furthermore, the mining industry is immersed in a proliferation of expert proprietary software applications that are well adapted to support the specialist activity or task for which they are designed. However, due to the disparate origin of these applications, the integration of the data that these applications require and/or produce presents a significant hurdle. In many instances, data is extracted from one application and entered by hand into a second application for required processing. Clearly, this is inefficient and subject to error.

The above circumstances that are unique to the mining industry reduces the agility of the business and lead to difficulties in solving and recognising problems, and to difficulties in being capable of taking advantage of competitive opportunities.

Hence, it is desirable to provide a means for accurately and efficiently modelling the mine planning process, over all time frames.

### OBJECT OF THE INVENTION

It is an object of the invention to overcome or at least alleviate one or more of the above problems and/or provide the consumer with a useful or commercial choice.

### DISCLOSURE OF THE INVENTION

In one form, although it need not be the only or indeed the broadest form, the invention resides in a system for facilitating integrated mine planning in a mining operation comprising:

a data module to store data objects; and

a management module in communication with the data module, the management module configured with at least one workflow having a series of interdependent processing steps representative of planning steps for a mine plan, the management module controlling the accessibility of one or more users to each of the steps within the at least one workflow;

wherein, at least one user is able to obtain one or more data objects from the data store, under the control of the management module, to process the one or more data objects to perform at least one processing step in the at least one workflow using a proprietary expert software solution.

Further features of the present invention will become apparent from the following detailed description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 shows an integrated mine planning system according to an embodiment of the present invention;

FIG. 2 shows a method of integrated mine planning according to an embodiment of the present invention;

FIG. 3 shows an exemplary execution stub according to an aspect of the present invention;

FIG. 4 shows a high level design for a workflow component according to an aspect of the present invention;

FIG. 5 shows a document management design according to an aspect of the present invention; and

FIG. 6 shows a queue management design according to an aspect of the present invention.

FIG. 7 shows an exemplary workflow configured within a management module of the integrated mining system of the invention shown in FIG. 1;

FIG. 8 shows a screen shot of a representation of a sub-workflow for a step in the workflow shown in FIG. 7;

FIG. 9 shows a further screen shot of a representation of a sub-workflow for a step in the workflow shown in FIG. 7;

FIG. 10 shows a screen shot of processing undertaken during a step in the sub-workflow shown in FIG. 8;

FIG. 11 shows a further screen shot of processing undertaken during a step in the sub-workflow shown in FIG. 8;

FIG. 12 shows a further screen shot of processing undertaken during a step in the sub-workflow shown in FIG. 8;

FIG. 13 shows a further screen shot of processing undertaken during a step in the sub-workflow shown in FIG. 8;

FIG. 14 shows a further screen shot of processing undertaken during a step in the sub-workflow shown in FIG. 8;

FIG. 15 shows a screen shot of the sub-workflow shown in FIG. 8; and

FIG. 16 shows a screen shot of the work flow shown in FIG. 7.

### DETAILED DESCRIPTION OF THE INVENTION

The present invention provides an integrated mine planning system and method that supports the integration of expert proprietary software solutions designed for specific business processes within a mining operation in a manner that allows planning of the mining operation over the short, medium and long term to be carried out in light of dynamic changes that occur at each of these distinct planning time frames.

The integrated mine planning process of the invention involves short term planning, medium term planning and long term planning sub-processes with each of these sub-processes being comprised of a series of interrelated, configurable workflows that utilize data from a plurality of proprietary point based solutions to achieve particular outcomes and provide data that is used within other workflows and other sub-processes.

Furthermore, each of the workflows within each of the short, medium and long term planning sub-processes is suitably comprised of sub-workflows, each contained wholly within it's respective parent workflow.

The system and method of the invention provides for a management tool to dynamically manage the planning process in an auditable, seamless and consistent manner across the mining enterprise in that data and workflows are managed by the method and system of the invention across a plurality of computing devices.

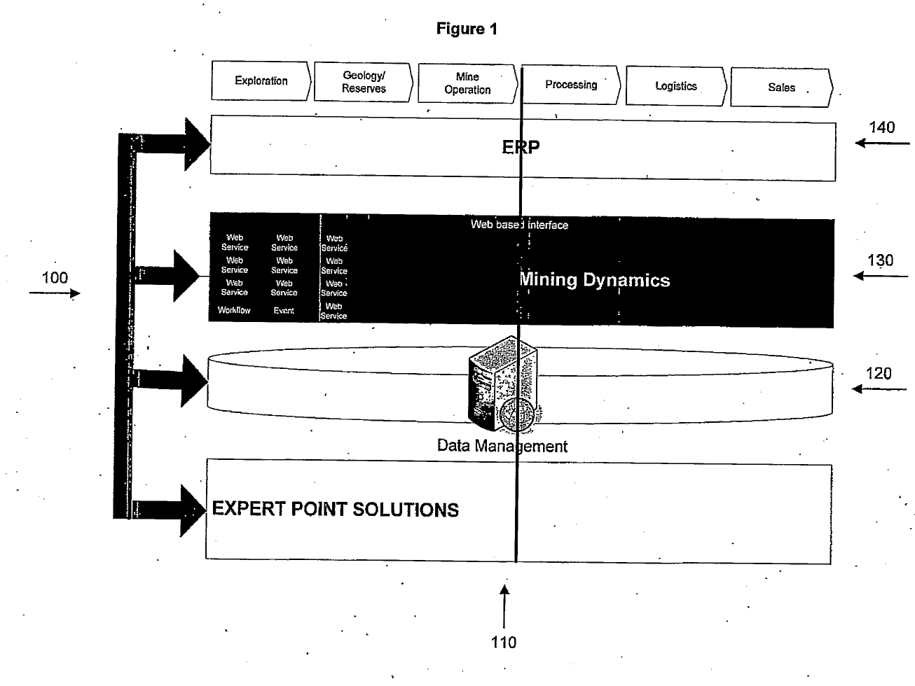

FIG. 1 shows an integrated mine planning system 100 according to an embodiment of the present invention. Mine planning system 100 comprises a plurality of known expert proprietary software solutions 110, a data module 120, management module 130 and ERP module 140.

The expert proprietary software solutions 110 are in the form of a plurality of point based solutions adapted to cope with discrete tasks within the mining process. Examples of such point based solutions include XPAC for estimation of mine production schedules, XERAS for estimation of costs of planned mine production, and other similar proprietary applications. Additionally, monitoring and recording applications form part of the plurality of proprietary software solutions 110.

A skilled person will readily identify other applications that advance the business benefit of discrete areas of the mining business and are employed within miring operations that form part of the expert proprietary software solutions 110.

Data module 120 is in the form of an object database for storing all relevant data and data models necessary for the mining process. Data is stored to and retrieved from the data module 120 by the management module 130 as will be discussed in greater detail below. Preferably, the data module 120 is in the form of spatial data management tier 120 for storing inputs to each expert proprietary software solution 110 and outputs from each expert proprietary software solution 110 as will be discussed in greater detail below.

It will be appreciated that data module 120 may be in the form of one or more distributed databases providing a seamless access point for user applications and proprietary software solutions 110.

Management module 130 provides a consistent interface to enable a user of system 100 to access the expert proprietary software solutions 110 in an open and consistent manner. Furthermore, management module 130 allows the access of data from the data module 120 and the update of data to the data module 120 in a seamless and consistent manner in order that the proprietary software solutions 110 can dynamically utilize this data at all stages of the mine planning process.

Management module 130 enables the proprietary software solutions 110 to interact seamlessly with the data in data module 120 in order that the mine planning process can integrate this data across all time frames necessary to form an effective enterprise resource planning system 140.

Management module 130 of the integrated mine planning system 100 of the invention provides a user with a consistent, managed interface to the data module 120. The management module 130 acts as a data management, translation and workflow automation layer between the disparate proprietary expert software solutions 110 via data module 120.

Data inputs required by each individual proprietary expert software solution 110 and the outputs these produce are stored within the data module in the form of spatial data management tier 120. Each data item has associated therewith meta-data to enable re-use of this data throughout the mining process, sub-process, workflow and/or sub-workflow as the case may be. This data is predetermined within the management module 130.

Identification of the inputs and outputs required by each proprietary expert software solution 110 is configured within management module 130 based on the stage within the planning process, sub-planning process, workflow or sub-workflow within which the relevant proprietary expert software solution 110 is being used. That is, the data requirements of any proprietary expert software solution 110 at some point within a workflow, for example, may differ from its requirements as the workflow progresses.

Thus, a workflow within the management module 130 is configured by the management module 130 to provide different inputs, manage different outputs and control the same proprietary expert software solution 110 in different ways throughout a workflow.

Input data required by a proprietary expert software solution 110 at a stage within a workflow is defined by specifying one or more meta-data queries, these queries being configured within the management module 130. Meta-data queries are executed against data module 120 in the form of a Spatial Data Management Tier by the management module 130 to locate the relevant information.

Suitably, a temporal aspect may also be applied to the search enabling the location of revisions of a data file meeting a specific set of criteria such as the last published data file produced by a proprietary expert software solution 110 and saved within data module 120.

Data files which are used as inputs for a proprietary expert software solution 110 may be in the form of any data file(s) stored within data module 120 in the form of Spatial Data Management Tier, not simply data from a different proprietary expert software solution 110. Suitably, such data inputs are automatically translated by the management module 130 into a format meaningful for a proprietary expert software solution 110 which requires that data for processing.

Input data files located while querying Spatial Data Management Tier 120 as part of a workflow is automatically retrieved by the management module 130 and communicated to a processing device running the proprietary expert software solution 110 in preparation for use during its processing.

After the management module 130 has retrieved the required input data from data module 120, the management module 130 begins automating the proprietary expert software solution 110 on a relevant processing device. Suitably, a relevant device has been predetermined within the management module 130 for that workflow.

For example, the senior geologist may have an application installed on their computer only and hence the management module 130 automatically initiates that application utilising the relevant data retrieved from the data module 120.

Preferably, the management module 130 starts up and configures the proprietary expert software solution 110 and communicates thereto the relevant input data file retrieved from data module 120 for use. The management module 130 invokes the necessary function(s) within the proprietary expert software solution 110 using an exposed Application Programming Interface (API). Optionally, other known methods may be employed to invoke necessary functions within the proprietary expert software solution 110.

The management module 130 then monitors the execution of the proprietary expert software solution 110 and tracks and manages the output data files produced as a result of this execution. Additionally, the management module 130 handles any exceptions or errors that arise as a result of the execution of the proprietary expert software solution 110.

Suitably, the level to which a proprietary expert software solution 110 is automated by the management module 130 is configured within the respective workflow in the management module 130. Thus, the level of automation may be restricted to the management module 130 fetching input data from the data module 120 and saving data files output by the proprietary expert software solution 110 to data module 120 with a user of the proprietary expert software solution 110 performing the actual work within the application.

Alternatively, management module 130 can fully automate the proprietary expert software solution 110, removing all interaction by a user of the proprietary expert software solution 110.

When the proprietary expert software solution 110 has completed, relevant output data created is identified by the management module 130 and is saved, archived and meta-data tagged into the data module 120.

Detecting completion, either successfully or in failure, of proprietary expert software solution 110 is based on criteria defined in the executing workflow by management module 130 and includes:
termination of the process;
signalling management module 130 directly from within proprietary expert software solution 110; or
creation of specific outputs as defined in the executing workflow's definition.

Identification of the relevant output data from proprietary expert software solution 110 is also based on criteria defined in the executing workflow and includes:
queries by management module 130 on meta-data associated with data files created by the proprietary expert software solution 110 including that generated by the processing devices' operating system (dates, times, filenames, etc);
meta-data generated by the proprietary expert software solution 110 itself; and/or
meta-data automatically associated with input data previously retrieved from the data module 120 in the form of Spatial Data Management Tier by the management module 130 which were used as inputs to the proprietary expert software solution 110.

Alternatively, a user of the proprietary expert software solution 110 may indicate to the management module 130 that the proprietary expert software solution 110 has completed execution.

Depending upon how a workflow is configured within management module 130, data output from a proprietary expert software solution 110 may be saved directly to the data module 120 with appropriate meta-data assigned to this data automatically by the management module 130 from the implicit context of that workflow's current state.

Alternatively, the management module 130 prompts a user to add (or update) the meta-data to be associated with the data output by the proprietary expert software solution 110 prior to the data being saved to the data module 120.

Suitably, the management module 130 has predefined rules associated with each workflow and sub workflow such that certain meta-data attributes cannot be changed by all users. That is, each user of the system 100 for the present invention has different access privileges such that meta-data associated with data stored within the data module 120 is only able to be edited by a user with requisite privileges. For example, a data files approval state (that is, it's state that indicates that all data has been approved and may be used for processing by other proprietary expert software solution 110) may only be edited, for example, by the manager of the mining operation.

Where output data from a proprietary expert software solution 110 overwrites an existing data stored within the data module 120 in the form of Spatial Data Management Tier 120, or changes any meta-data associated with it, a new revision of the data file is created and stored.

This new data immutably binds both the metadata and data together. Further changes to the file, or metadata, result in a new revision. These old revisions (metadata and data file) are retained in the data module 120 in the form of Spatial Data Management Tier so as to retain a full audit trail therein and to enable repeatability of downstream processes.

Previous revisions of data stored within the data module 120 in the form of Spatial Data Management Tier 120 are retained, along with associated meta-data at the point in time a new revision of that data is created. Revisions, files and meta-data are treated as a single immutable object and any changes to the data or meta-data of a given item results in management module 130 creating a new revision and applying the changes to that new revision. The newly modified revision of that data is then marked as the most recent.

Suitably, the meta-data of historical data revisions of a data file stored within data module 120 is able to be searched by the management module 130 and data at that point in time retrieved.

For example, a workflow within the management module 130 is able to be configured to always retrieve the last ‘Approved’ data file created by a proprietary expert software solution 110 and stored within the data store 120, rather than the current copy of that data store which may be under review, a work in progress, etc. by a different workflow within the sub-process or planning process.

Meta-Data associated with a data file can be added or removed from the current revision of that data file by a workflow within the management module 130 with no effect on historical versions of that data file. Thus, meta-data can be evolved over time as more information about a data file becomes available, such as during the planning phases.

Additionally, a user's account details, or other suitable identifier of the user, is also bound by the management module 130 to changes made against a data file's revision and/or the meta-data associated with that data file.

Preferably, meta-data identifying the user, the role that the user is performing (eg. planning engineer) and the location within the process, sub-process, workflow and sub-workflow which that user is creating or modifying data with the proprietary expert software solution 110 is immutably bound together and stored by the management module 130 in the data module 120.

Suitably, meta-data associated with a data file is populated directly by the management module 130 by extracting information from the data file by a series of preconfigured rules maintained by the management module 130. Alternatively, meta-data associated with a data file is populated by a user. Preferably, a user's ability to edit meta-data associated with a data file is restricted such that this may only occur during execution of a workflow within the management module 130 and only when that workflow has been configured to allow them to do so.

The management module 130 of the system 100 of integrated mine planning of the invention provides a seamless data access point for proprietary expert software solution 110. The management module 130 provides an interface to data stored within the data module 120 which can be utilized by disparate proprietary expert software solution 110 to directly access data and metadata stored therein.

Additionally, the system 100 of the invention integrates itself with the interface's of proprietary expert software solution 110 through configuration of a workflow within the management module 130 to produce deliverable data.

Furthermore, the system 100 of the invention provides management for proprietary expert software solutions 110 such that, form the proprietary expert software solution's 110 viewpoint, there is a level of unawareness that this is occurring. In this way, the system and method of the invention is robust and flexible and may be configured to operate with any form of proprietary expert software solution 110.

In all cases, the interface with the proprietary expert software solution 110 and the data input and output from these proprietary expert software solution 110 is audited, secured and managed by the management module 130.

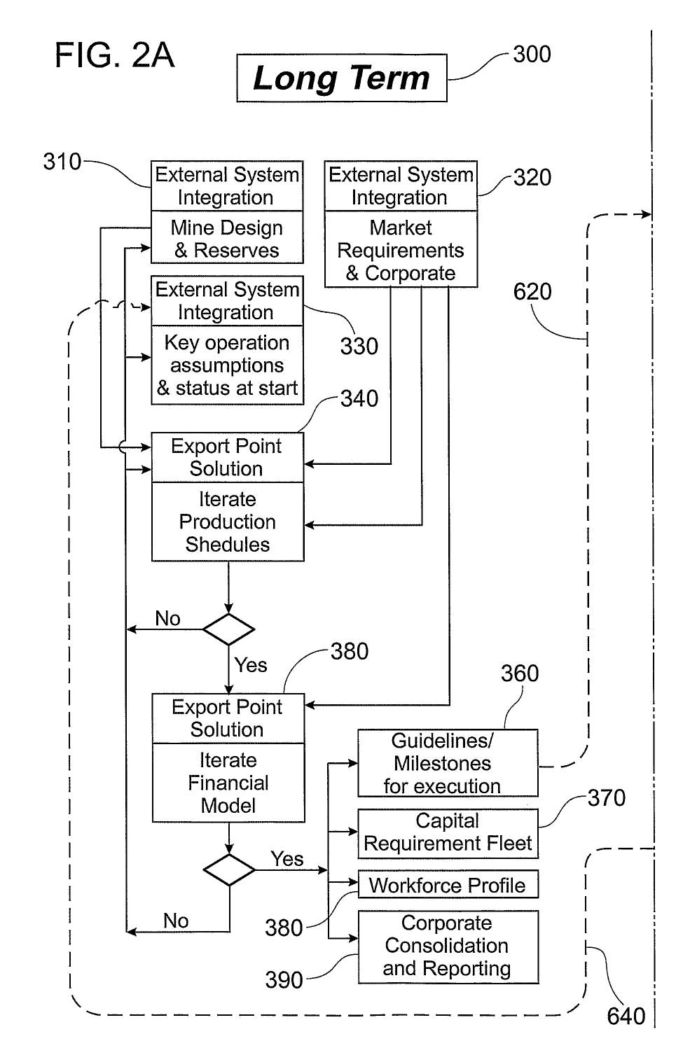

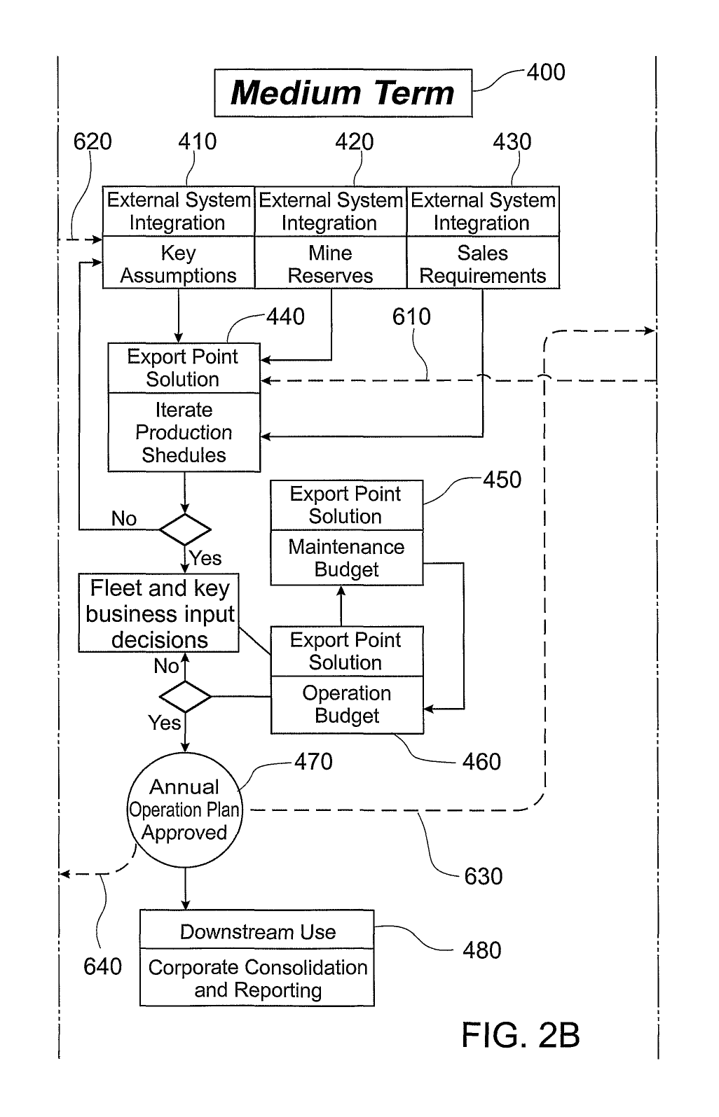

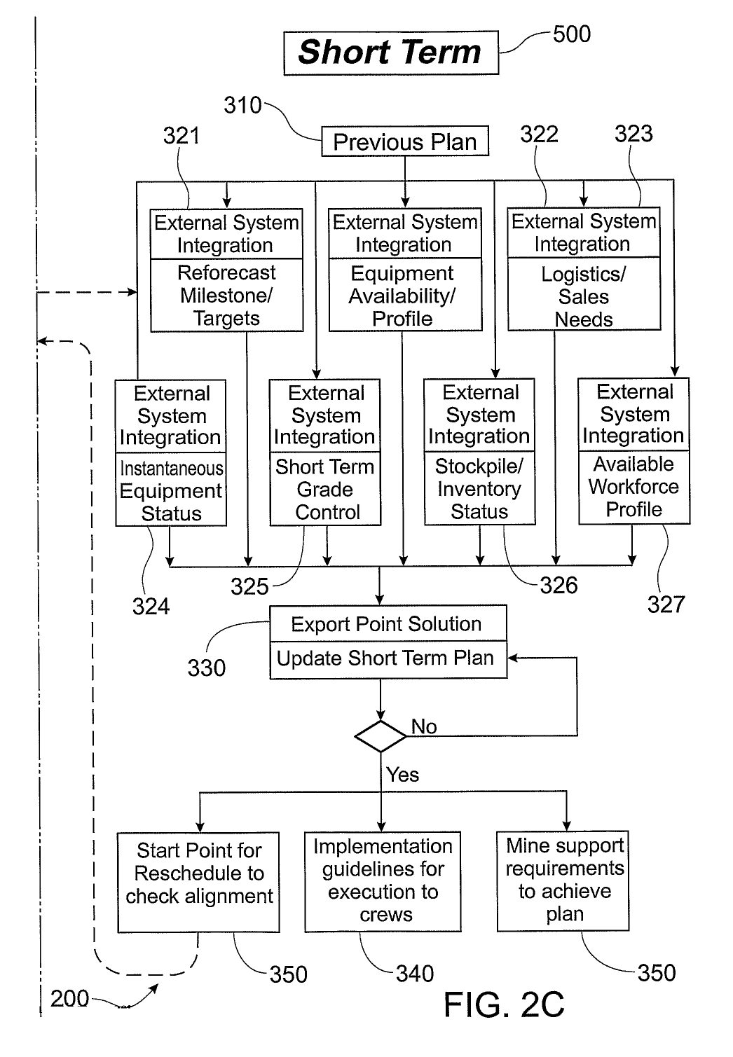

FIG. 2 shows a method 200 of integrated mine planning according to an aspect of the present invention. As discussed previously, planning in a mining operation is conducted over the short term 500, the medium term 400 and the long term 300 with each of these planning sub-processes having differing constraints and deliverables.

The short term operations planning sub-process 300 utilizes an existing forecast data file 310 as the principal data input. Various current status workflows 321-327, each utilizing various data items stored within data store 120 which are manipulated by various proprietary expert software solution 110 to proceed with the current short term plan sub-process 300.

As previously mentioned, the existing forecast data (310) used during the sub-planning process may not be the current working version but instead be the last approved version of this data, as indicated by meta-data stored in data module 120. As previously mentioned, a Workflow can be configured to utilize a specific forecast version meeting some meta-data criteria, such as the last published/approved version of the data item.

Such status input data include updated short term production mile stones 321, current equipment availability 322, stockpile inventory 323, etc. As previously mentioned, the data from these status inputs is created by disparate proprietary expert software solution 110. Utilizing the management module 130 of the present invention, consistent data can be seamlessly and dynamically viewed regardless of the type of program that has created this data in order that the short term planning sub-process 300 can continue.

A further expert solution 110 then gathers this data in a dynamic way and performs a new short term forecast 330. This may be an iterative process with the short term forecast being accepted and published. Production personnel then are provided with the specific operation deliverables 340,350 necessary to achieve this new short term plan. Additionally, the management module 130 utilizes the published and accepted short term plan 300 to check for alignment with the medium term planning sub process 400 as will be discussed below.

The medium term planning sub process 400 utilizes the updated short term plan 440, communicated via feedback loop 610, combined with various other data relating to business objectives 410,420,430 from the long term plan 300 stored within the data store 120 as a staring point. This data is iterated to produce the best case business plan to implement that reflects both the current operational data from the short term plan sub process 500 and the current strategic focus from the long term plan sub process 300.

Once data relating to an acceptable medium term plan has been completed the approved plan is published 470. This data is then stored within the data store 120 in order for it to be operatively communicated 630 to the short term plan process 500 in order that the relevant data can used in the next revision of this short term operation plan 500 by the proprietary expert software solution 110. Additionally, data related to the current medium term plan sub process is stored within the data store 120 in that it is operatively communicated 640 to the long term plan sub-process 300.

The long term planning sub-process 300 utilizes the data from the most recent published medium term plan 330, as identified by its associated meta data and also various other data stored within the data module 120 such as the current mine design data 310 and data related to market and corporate requirements 320 as a starting point in the planning process. The long term plan is iterated based on this current data to provide the best case business plan to implement. Any adverse changes in the medium and short term plan feed back to the long term plan (via 610 and 640) and, as such, business/technical solutions can then be devised in order to ensure that the rate of return of the operation is not adversely affected.

Once the long term plan has been completed, the relevant updated guidelines are stored in data store 120 and operatively communicated (620) in order that the next revision of the medium term plan process accommodates for these change in guidelines.

Hence, the integration and synchronization of operational and business data between the various planning timeframes enables a mining operation to stay current with the status and impact of changes across each distinct, short, medium and long term planning time frame and hence provides the business with a rapid quantification of the business position and allows an efficient comparison with the planned or anticipated outcome for each reporting period.

Effectively, an early warning detection and response system is created where previously a lack of integration and synchronization has led to unnecessary business inefficiency and lack of ability to respond to operational changes.

In effect, a dynamic measuring, reporting and reforecast model is provided across the operation with business data and technical data being seamlessly integrated from a variety of proprietary expert software solution 110.

Furthermore, the ability to integrate these disparate proprietary expert software solution 110 across a single time frame or over all of the planning time frames 300-500 enables workflow control to dynamically evaluate current status or enact relevant changes to business/technical plans to overcome unforeseen status changes and also to publish, distribute and store permanent records to provide an auditable business process.

As previously mentioned, this integration is facilitated by the management module 130 of the present invention. Preferably, management module 130 is implemented using Microsoft NET and interoperable technologies to allow editing of workflow data and functionality. Suitably, the Workflow processing component of management module 130 is hosted as one or more external processes.

The management module 130, performs data exchange and transfer via open and proprietary XML. Alternatively, other metadata paradigms may be employed. In this way, the data types that are unique to mining may be accurately described in order that seamless integration across the mining enterprise may be achieved.

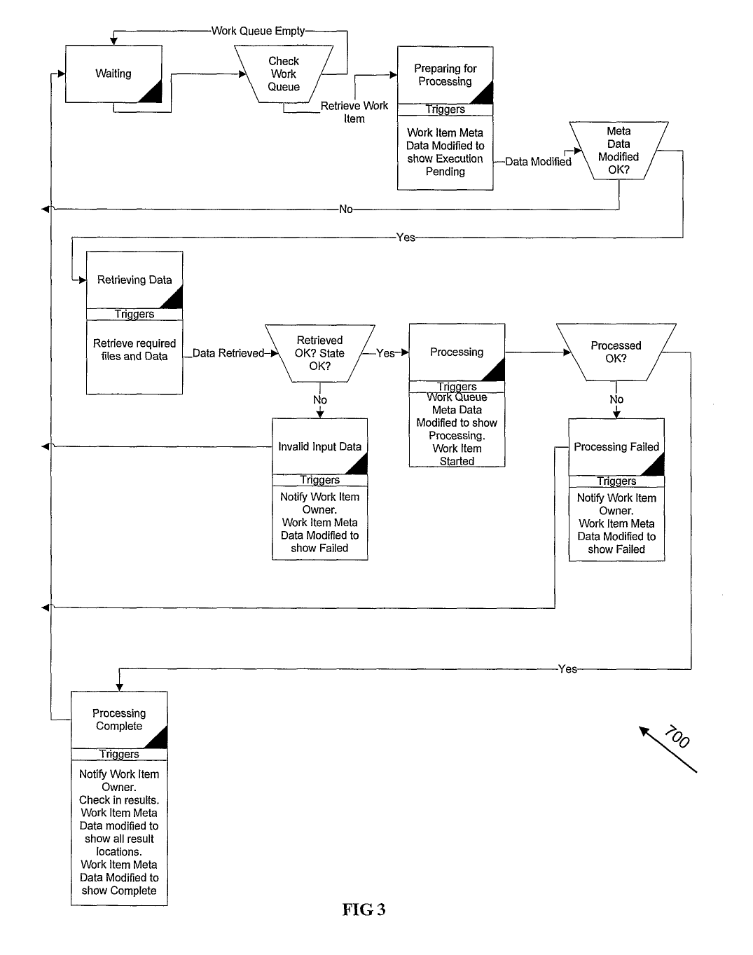

FIG. 3 shows an exemplary execution manager 700 controlled be management module 130 on a users computing device. Execution manager 700 communicates, under control of the management module 130, with one or more proprietary expert solutions 110 on the users computing device in order that all workflow data may be accessed, archived and/or stored to the data module 120.

The execution manager 700 requests authorization from the management module 130 to perform the workflow and, upon completion, notifies the management module 130 of the outcome resulting from the execution, regardless of successful execution or otherwise.

The execution manager 700 polls the management module 130, requesting a list of workflows that the computing device executing the execution manager 700 may be able to achieve. Once a valid workflow event has been identified, the execution manager 700 requests execution of this work flow from the management module 130. At this point, the data related to the work in question is extracted from the data module 120 by the management module 130 and granted to the execution manager 700 of the processing device in the form of an XML file.

The management module 130 sets this work item within the workflow to a state of “Being Processed”, preventing other execution managers 700, possibly on other computing devices, from performing the same work in parallel.

As previously discussed, the data contained within the workflow is directly related to the input files, output files, executable path and arguments, and events that should be processed by a proprietary expert software solution 110 in the event of execution success or failure.

The input files are retrieved from the data module 120, and the output files are also stored within the data module 120 by the management module 130. The execution manager 700 reports any mode of execution failure back to the management module 130, including but not limited to:
Being unable to execute the application;
Being unable to retrieve the Execution Description XML;
Being unable to process success and failure events; or
Having the work request rescinded (There exists a facility for the management module 130 to request cancellation of an already running workflow on a computing device)

Some of the above events mean that execution of the workflow may leave the workflow in an invalid state (i.e. neither the Success or Fail events are possible to report when the execution manager 700 is not capable of reading the Execution Description XML) and in this case it is possible to retry the execution of the application after making the appropriate configuration changes.

As previously discussed, the management module 130, performs data exchange and transfer via XML. Alternatively, other metadata paradigms may be employed. In this way, the data types that are unique to mining may be accurately described in order that seamless integration across the enterprise may be achieved.

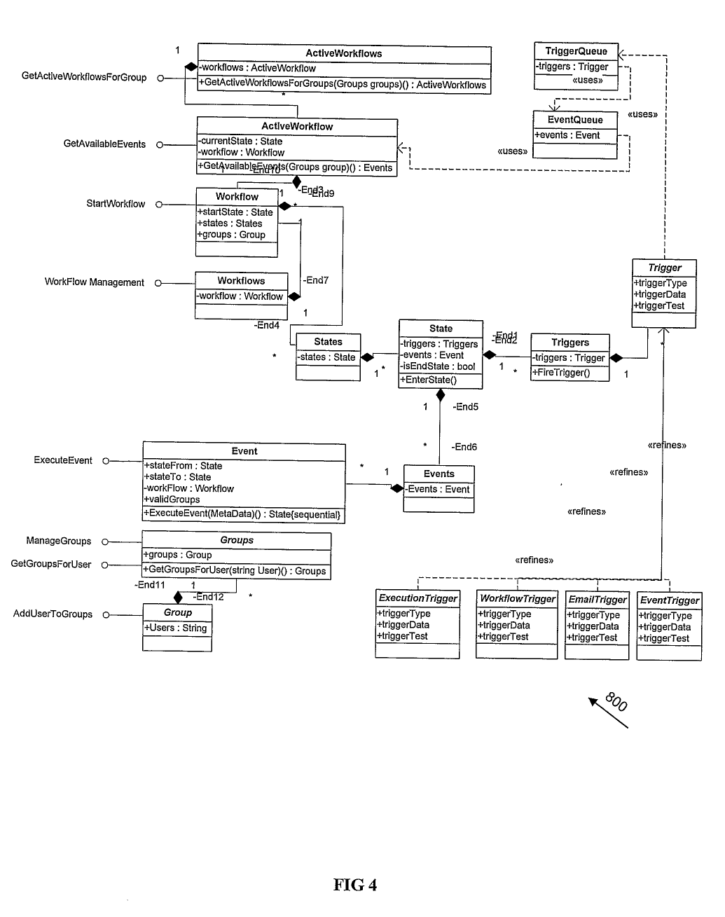

FIG. 4 shows a high level design for a workflow 800 according to an aspect of the present invention. As previously discussed, workflow 800 is configurable within management module 130.

FIG. 5 shows a document management design 900 according to an aspect of the present invention. The document management design 900 is exemplary of the process undertaken by management module 130 by which metadata is bound to data stored within data store 120.

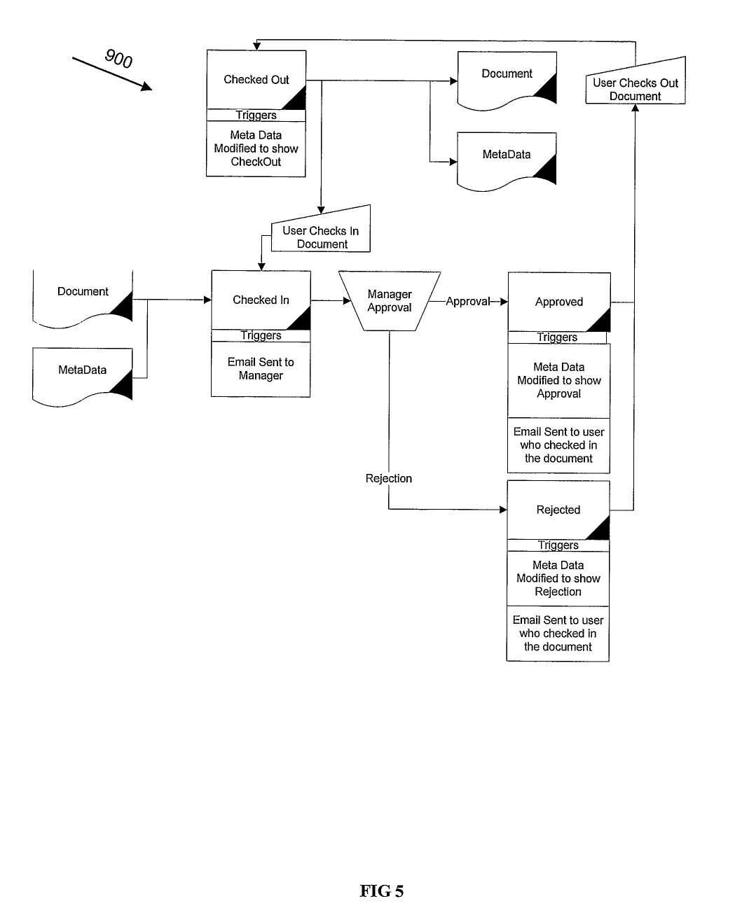

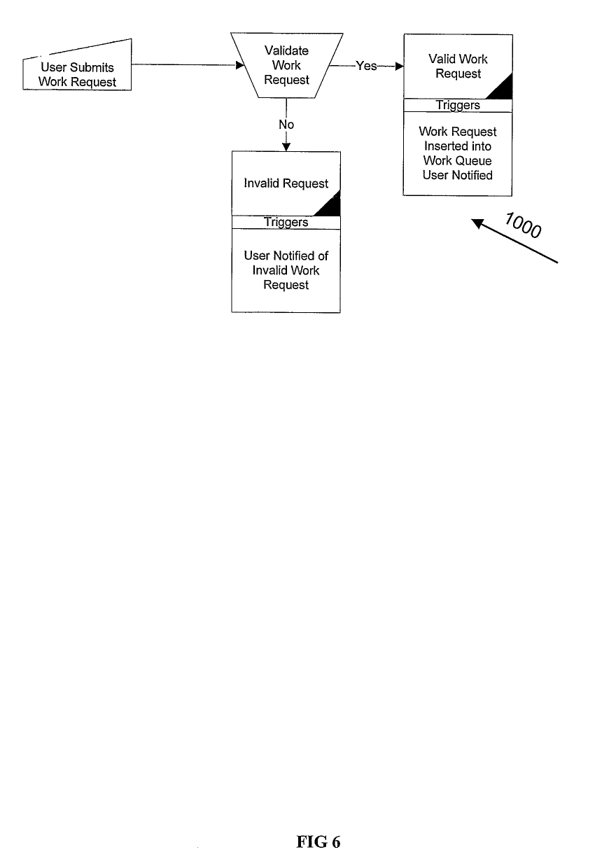

FIG. 6 shows a queue management design 1000 according to an aspect of the present invention. In this exemplary embodiment, the execution manager 700 executing on a users computer submits a request to the management module 130 to access data stored within data store 120 to work on a workflow configured within the management module 130.

FIGS. 7 to 16 show an example of an embodiment of the integrated mine planning method and system of the invention with reference to exemplary screen shots which a user of the method and system of the invention would interact with on their processing device to undertake a workflow.

As previously mentioned, a workflow consists of a series of inter-related steps configured within management module 130 organized to achieve particular outcomes within the mine planning process. A workflow may further include one or more interdependent workflows contained solely within a parent workflow.

The example discussed with reference to FIGS. 7-16 is framed from the point of view of a single user of the integrated mine planning system 100 of the invention. In this case, the user is a Geologist within the mining operation working on a single computing device having an execution manager running thereon in communication with the management module 130.

It will be appreciated that a plurality of users may simultaneously be operating computing devices in communication with management module 130, the management module 130 providing administration over the allowability of access to data in the data module and workflows configured within the management module 130 as previously discussed.

FIG. 7 shows an exemplary workflow configured within the management module 130 of the integrated mining system 100 of the invention. As shown, the user is presented with a relevant workflow by the management module 130. The workflow is presented visually and the dependencies for each of the steps within the workflow are indicated.

In the example, it can be sent that the dependencies for “Process 3” within the have already been completed. That is, the management module 130 has been configured such that “Process 3” cannot be executed by a user until the previous processes have been completed. The interactive workflow diagram shown in FIG. 7 is generated and updated automatically by the management module 130 as user's progress through each workflow.

To begin work on “Process 3”, the Geologist clicks the “Process 3” block in the interactive workflow shown in FIG. 7 to drill down in to the sub-workflows for this process.

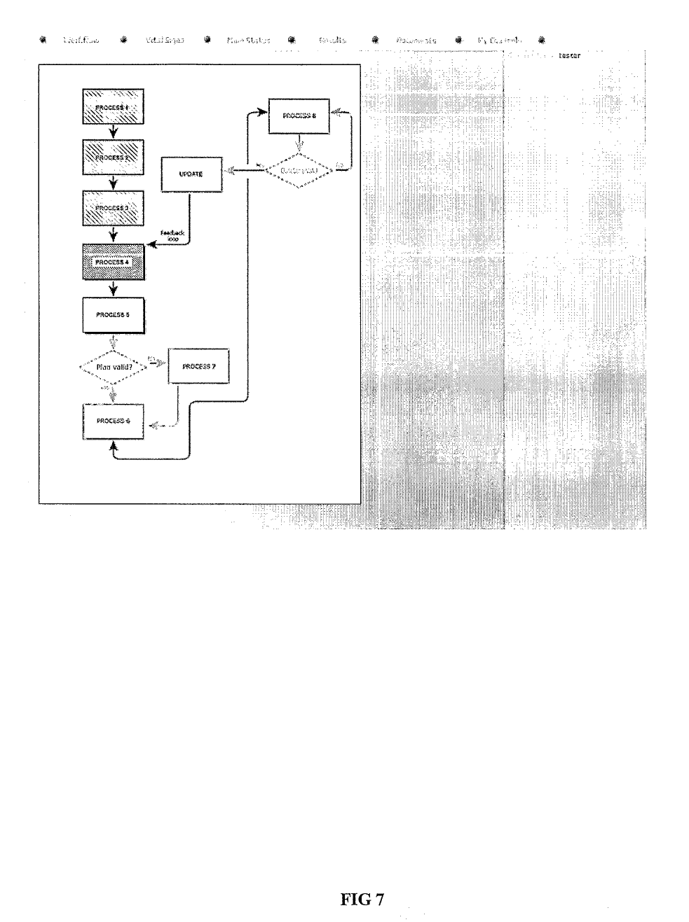

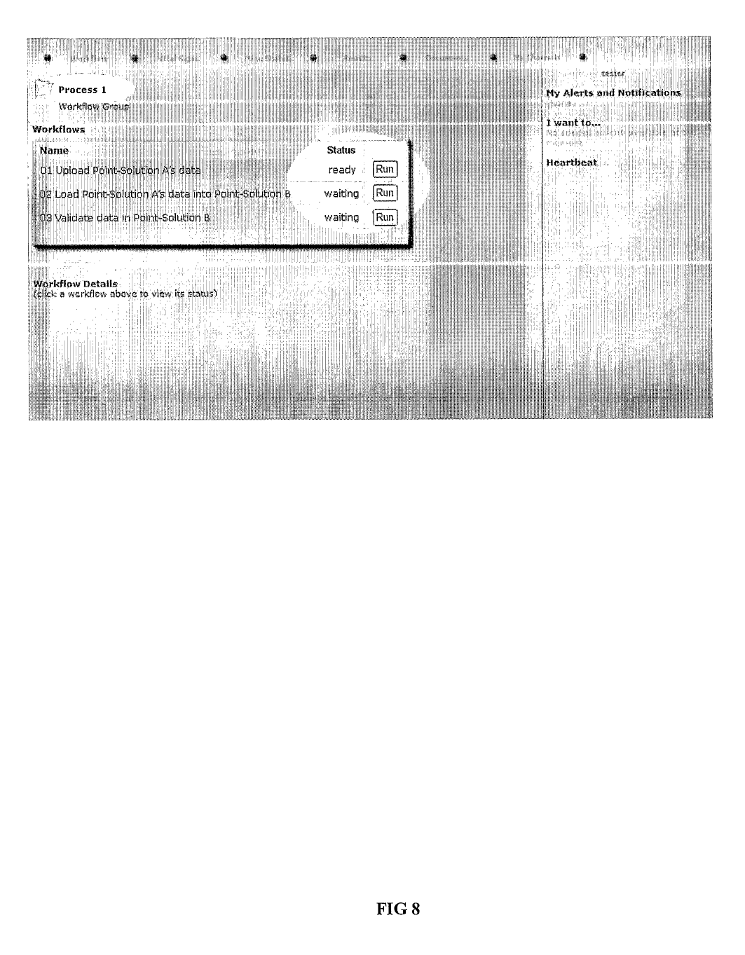

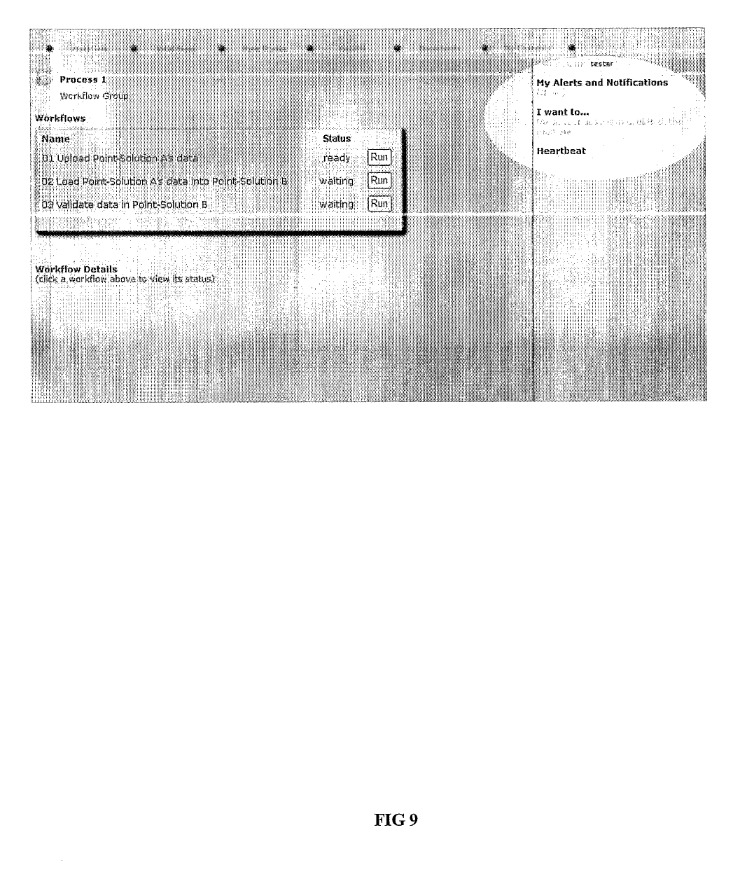

FIG. 8 and FIG. 9 show a screen shot of the representations of the sub-workflows for “Process 3” in the workflow shown in FIG. 7. In the example, the step indicated by “Process 3” in the workflow shown in FIG. 7 has a sub-workflow having three interdependent steps.

It will be appreciated that, whilst the steps in the sub-workflow shown in FIG. 9 and FIG. 9 are represented as a list, the representation may be in the form of a graphical flow chart as shown in FIG. 7. This representation is configurable within the management module 130 across all execution managers in communication therewith. Alternatively, the representation may be configured by a user within the execution manager running on their computing device.

The sub-workflow has three steps and it can be seen that only step 1 has a status of “ready” meaning that only this step may be executed by the user as steps 2 and 3 are dependent upon the outcome of processing in step 1.

As seen most clearly in FIG. 9, the user, in the form of a Geologist, is presented with context sensitive data feeds, or channels. The management module 130 configures this are on a per workflow basis to communicate information to relevant users, or groups of users, within this area of the screen. Such information may include, but is not limited to, required data or documents not currently stored within data store 120, messages for the current user, context sensitive help for the user, information feeds pulled from other systems, and the like.

Preferably, the context sensitive data feeds are interactive and allow the user to drill down into additional relevant information.

To begin processing in the sub-workflow, the Geologist clicks the run button next to step 1 in the sub-workflow. In this example, this step involves uploading data from a proprietary expert software solution 110 in the from of Point Solution A and is labelled in the screen shot as “01 Upload point-Solution A's data”.

This step in the workflow requires a number of steps, managed by the execution manger on the Geologists computer as configured by the management module 130. This is discussed further below.

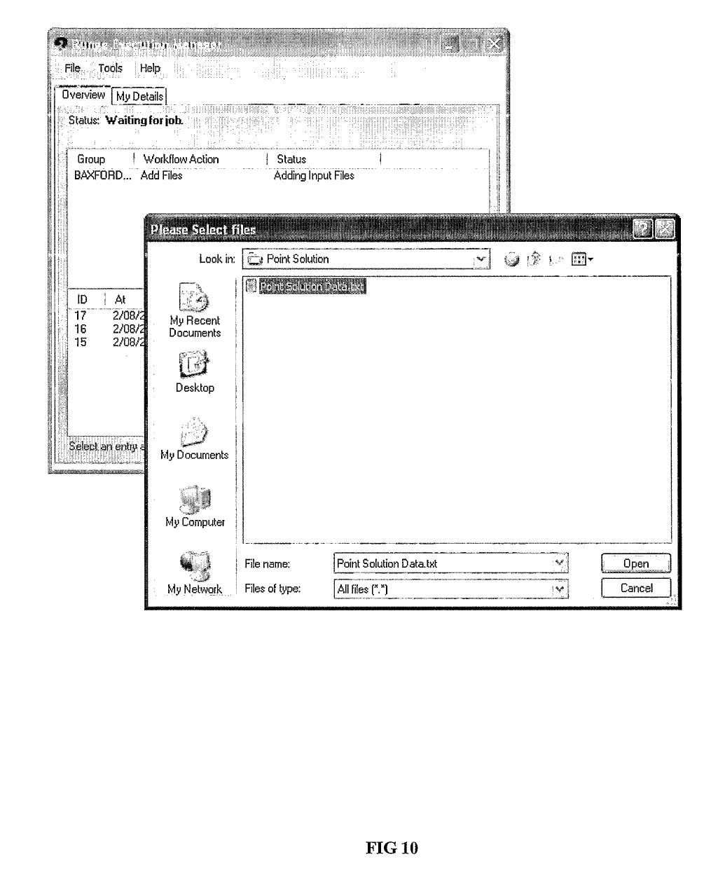

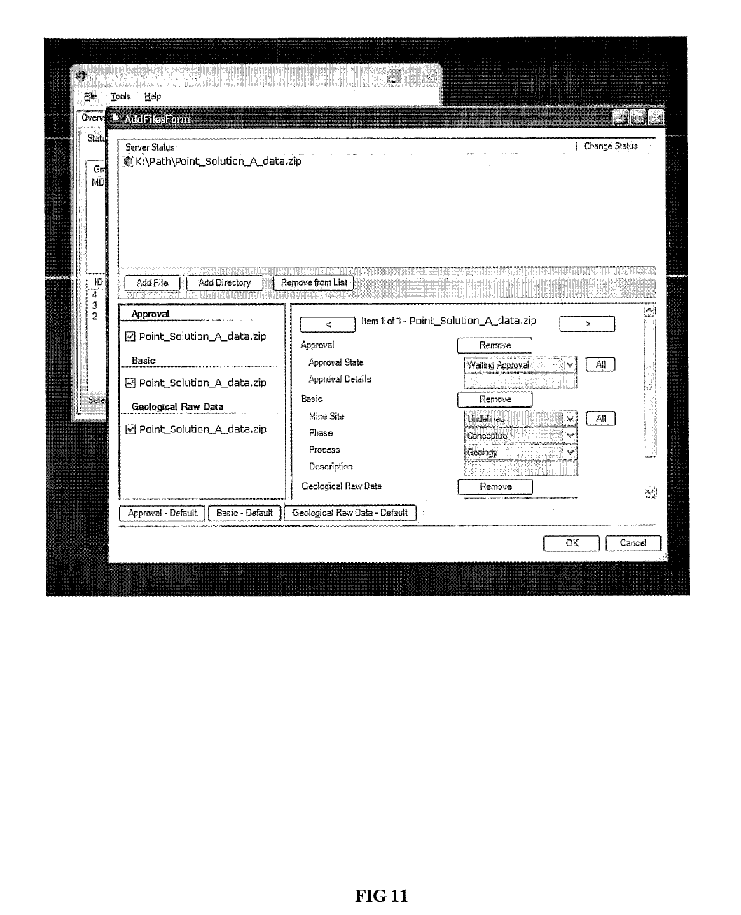

FIG. 10 and FIG. 11 show screen shots of processing undertaken during step 01 in the sub-workflow shown in FIG. 8. A series of instructions configured within the selected workflow by the management module 130 are queued within the execution manager application executing on the Geologist's computing device. These instructions are translated to the low level operating system language running on the computing device and result in the Geologist being prompted to select a data file from proprietary expert software solution 110 in the form of point Solution A as seen in FIG. 10.

For example, this data may be raw borehole data entered into the Geologist's computer which has been processed by the proprietary expert software solution 110 in the form of Point Solution A and has been stored locally, on the Geologists computer, but has not been added to the data module 120 of the system 100.

After the Geologist as selected the appropriate file, the Geologist is prompted to classify meta-data in respect of this data as seen by way of example in the screen shot shown in FIG. 11.

Suitably, the types of meta-data which can be associated with a file are determined automatically by the management module 130 based on the type of data that is being classified. For example, a repository for geological related files would be configured with rules defining required meta-data types of documents it contains. Repositories can also define optional meta-data types. That is, the data module 120 of the invention can be configured to have repositories of application specific data. As previously discussed, the data in data store 120 may be located on a single data base or on a distributed data base, with repositories located on geographically separated data bases. However, preferably the data appears to a user to be stored on a single store.

Furthermore, security permissions are suitably associated with both the prompt and data store 120 to restrict user's choices in respect of metadata classification. Optionally, metadata options are predefined by management module 130 for each user within a workflow.

As previously discussed, where a data file already is stored in the data module 120 and the current data file for uploading is an updated data file, a new revision is created for that updated file and it's meta-data. In this way, both data and meta-data stored within data module 120 of the invention are persistent and immutable. Updated data files are added with the previous version retained within data store 120.

The data is then exported by the Execution manager running on the Geologist's computer to the management module 130 for saving within the data module 120 of the system 100 of the invention.

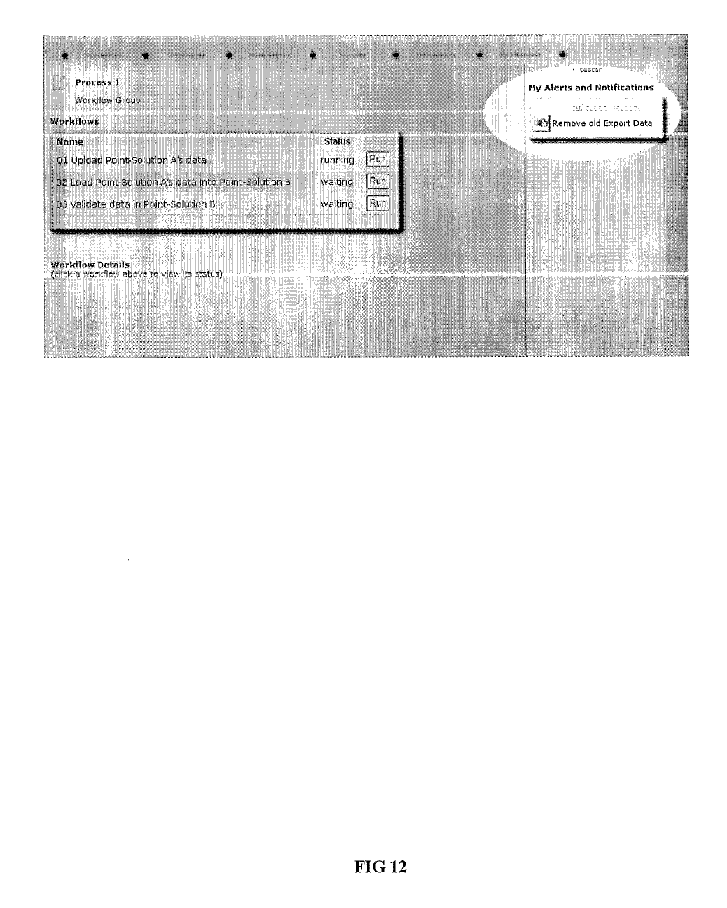

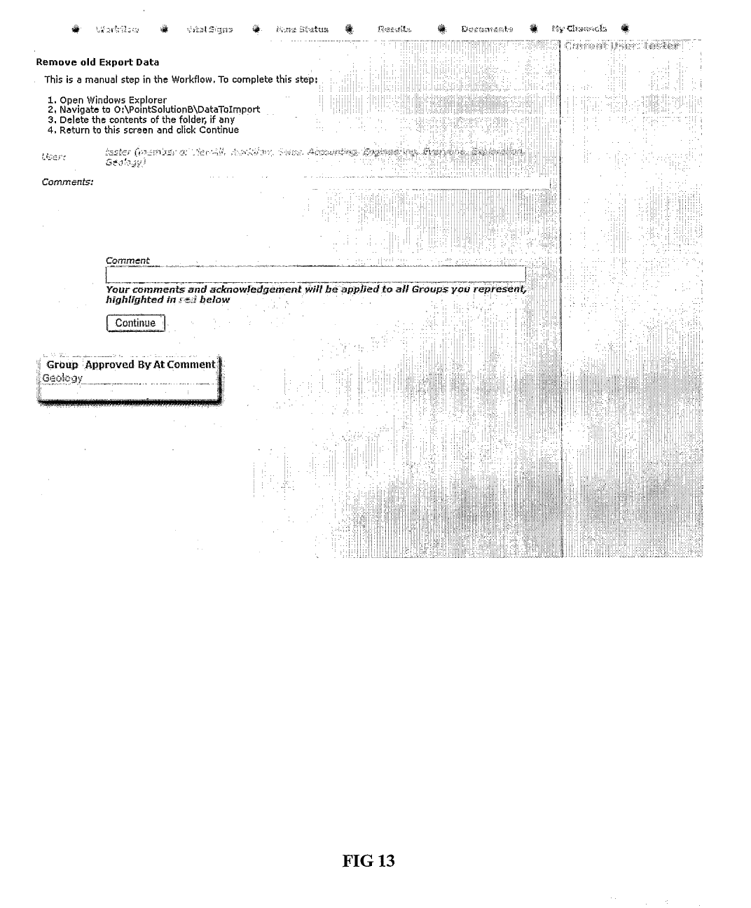

FIG. 12 and FIG. 13 show further screen shots of processing undertaken during step 01 in the sub-workflow shown in FIG. 8.

With Point Solution A's data now stored within the Invention, the workflow has been configured by management module 130 to notify the Geologist with instructions for manually completing the next step.

In the example, this notification appears in the context sensitive ‘channels’ list shown on the far right of FIG. 12.

Suitably, management module 130 may be configured to require a user to complete a form, checklist or the like in these notification messages. Optionally, management module 130 may configure the workflow to require approval from a multiple staff members before further processing in the workflow may take place.

The Geologist then clicks the message to display the instructions provided by the management module 130 as shown in FIG. 13.

Having completed the manual step as in indicated in FIG. 13 and clicked “Continue” shown in the screen shot, the Workflow is configured by management module 130 to retrieve and decompress the inputs required by step “02 Load Point-Solution A's data into Point-Solution B” in the sub-workflow shown in FIG. 8. The criteria for these inputs are defined in the workflow as configured by management module 130.

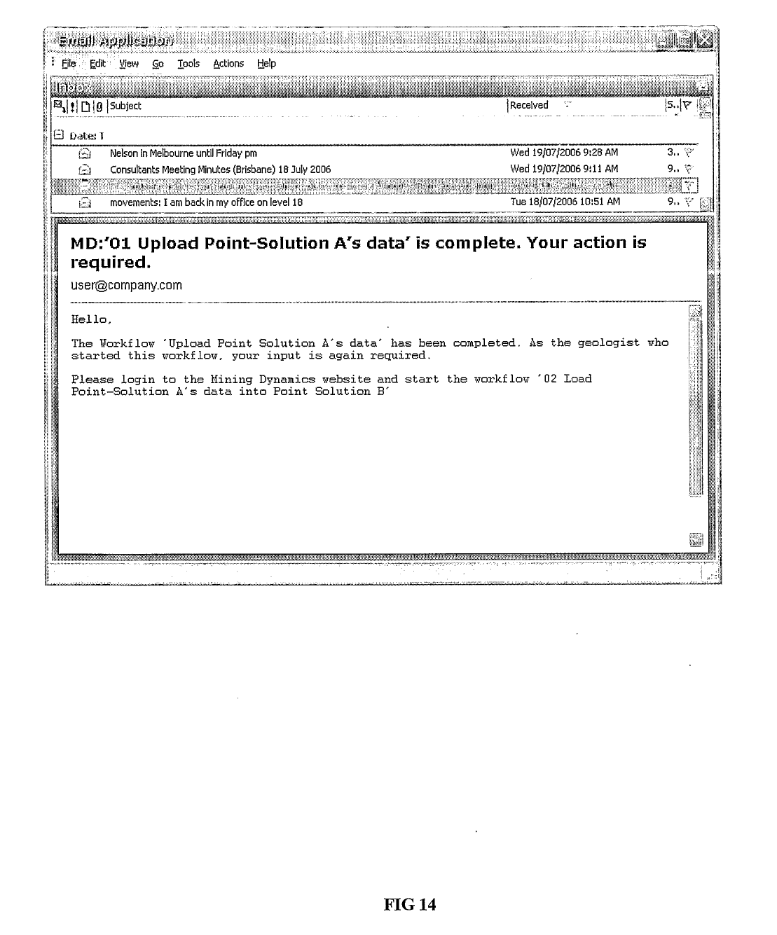

FIG. 14 shows a further screen shot of processing undertaken during step 01 in the sub-workflow shown in FIG. 8.

After the management module 130 has retrieved the required data from data store 120, communicated the data to the execution manager running on the Geologist's computer and pre-processed this data for input into proprietary expert software solution 110 in the form of Point Solution B, the management module 120 communicates a notification email to the Geologist informing him to start the step “02 Load Point-Solution A's data into Point-Solution B” in the sub-workflow shown in FIG. 8.

Alternatively, other communication channels are used by management module 130 to notify the user of the completion of processing and/or input require. Such communication channels include, but are not limited to, mobile phone text messages (“SMS”), web-based notification, popup's thru the Execution Manager and executing 3^{rd} point solutions to allow specific message handling.

Upon receipt of the notification message, the Geologist enters into the execution manger application again, as controlled by the management module 130, and continues processing.

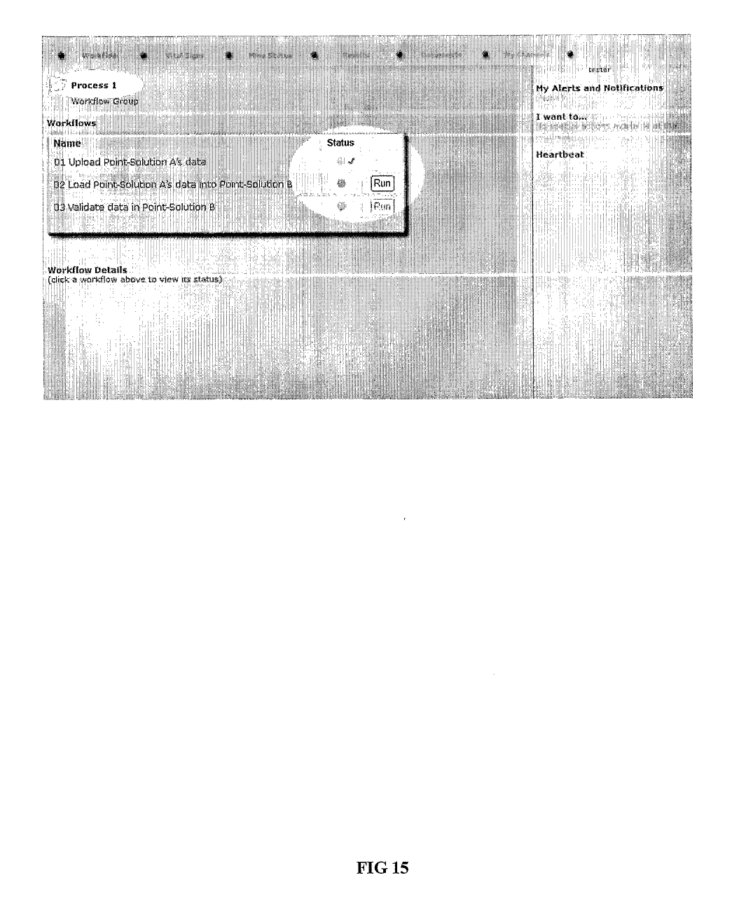

A shown in FIG. 15, the sub-workflow now indicates that step 1 in the sub-workflow is complete allowing dependent step 2 to be accessed by the Geologist in order that the sub-workflow may continue.

The Geologist, and/or other staff as required, these other staff members being notified of their required involvement by way of notification messages, continue processing the sub-workflow until all steps in the sub-workflow have been completed.

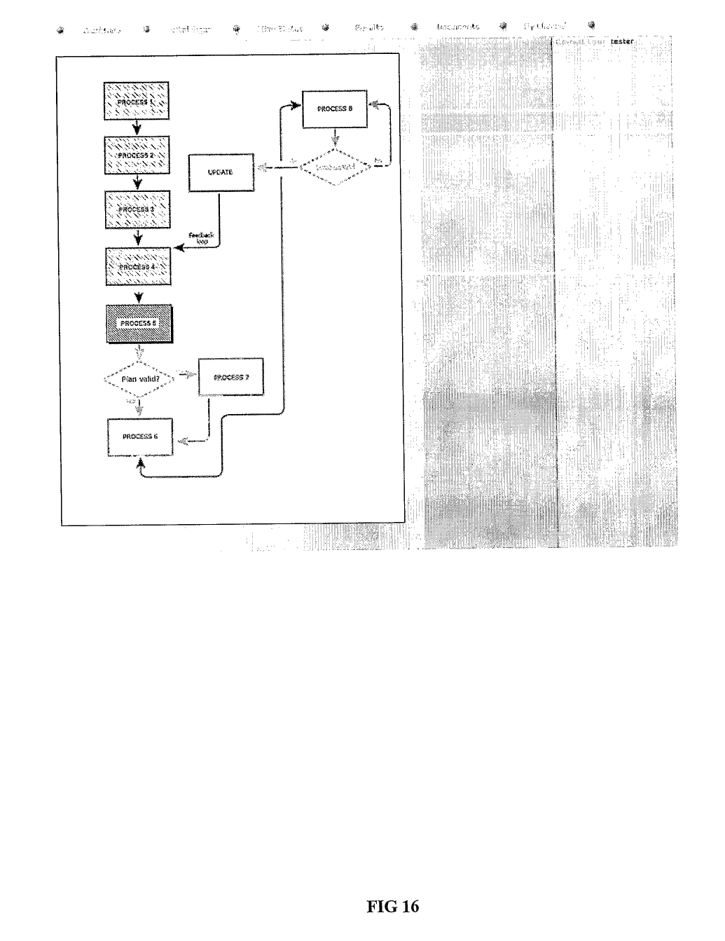

At the completion, of the sub-workflow shown in FIG. 8, process 3 in the workflow shown in FIG. 7 has been completed unlocking process 4 in the workflow, as configured by management module 130, in order that further processing in the workflow can take place. FIG. 16 shows a the workflow shown in FIG. 7 with step indicated by “Process 4” being unlocked by management module 130.

In the example workflow discussed above, data from Point Solution A was exported and saved in data store 120 by management module 130. As previously stated, this data and its associated meta-data are associated together as an immutable single item. Full historical revisions of each item are retained in the data store 120 enabling users and management module 130 to locate documents and data at a specific point in time, not necessarily being the most recent version of this data. An example of this is the ability to locate the last ‘approved’ versions of all documents. Suitably, this data may be browsed by a user of the system 100.

The integrated mine planning method and system of the invention provides for a systematic method of processing data from disparate proprietary expert software solutions in a manner that ensures data integrity across all time frames of the mine planning process. The management module has configurable workflows to ensure that specific users access approved data at a time within a workflow forming part of the planning process as configured and approved by the management module in a manner that communicates data generated by a plurality disparate proprietary expert software solutions for processing by other proprietary expert software solutions.

The invention overcomes at least some of the problems in the prior art which result in mining operations having pockets of enterprise critical data strewn across processing devices in the operation, and indeed in paper form on desks, to provide a system and method of integrated mine planning that ensures that changes in underlying technical and enterprise data generated within the operation is rapidly captured and able to be used at other locations within the mining operation for planning purposes.

Supported by the use of modern technology, this invention provides a robust, customisable means of integrating the specific short, medium and long range planning processes used within a mining company. The important distinction to make here is that this invention is flexible enough to fit the unique processes being used by each company without enforcing any pre-defined rigidity.

A further advantage delivered by this invention is the formation of a basis for an “all in one place” integration with ERP systems and other downstream users of mine operations forecast information. Not only is the information co-ordinated and stored in one location, it represents a single source of all necessary business information relating to the mine operations forecast and prevents the need for duplication and redundant storage of data.

The method and system of integrated mine planning according to the present invention provides a large number of advantages over the current planning process in mining operations. These advantages include, but are not limited to:
The development of timely and comprehensive updated future mine plans.
The automated generation of updated future mine plans based on current business data.
The establishment of a repeatable process capable of working with and coordinating a wide variety of independent expert solutions from disparate vendors.
The establishment of a transparent auditable process with full record keeping to provide justification for updated planning models.
A mine planning process that is established that is able to cater for the unique environment in which the mining business operates.
Providing a computer solution that seamlessly interfaces with existing business support systems without the need to provide additional IT systems.
Providing a solution that supports a holistic analysis of a mining operation to provide the best business alternatives based on the current operational status of the operation.

Throughout the specification the aim has been to describe the invention without limiting the invention to any one embodiment or specific collection of features. Persons skilled in the relevant art may realize variations from the specific embodiments that will nonetheless fall within the scope of the invention.

It will be appreciated that various other changes and modifications may be made to the embodiment described without departing from the spirit and scope of the invention.

1. A system for facilitating integrated mine planning in a mining operation comprising:
a data module to store data objects; and
a management module in communication with the data module, the management module configured with at least one workflow having a series of interdependent processing steps representative of planning steps for a mine plan, the management module controlling the accessibility of one or more users to each of the steps within the at least one workflow;
wherein, at least one user is able to obtain one or more data objects from the data module, under the control of the management module, to process the one or more data objects to perform at least one processing step in the at least one workflow using a proprietary expert software solution.

2. The system of claim 1 wherein, each of the one or more steps within the at least one workflow has one or more sub-workflows, each sub-workflow contained solely within a respective parent workflow, each sub-workflow having a series of interdependent processing steps representative of planning steps for a mine plan.

3. The system of claim 1, wherein data created by the proprietary expert software solution is stored within the data module under the control of the management module.

4. The system of claim 1, wherein each data object stored within the data module has metadata associated therewith.

5. The system of claim 4, wherein the metadata is immutably bound to the data objects stored within the data module.

6. The system of claim 4, wherein the metadata types to be associated with a data object created by a proprietary expert software solution are configured by the management module.

7. The system of claim 4, wherein the metadata types to be associated with a data object created by a proprietary expert software solution are configured by the management module based upon a metadata type selected from the group comprising:
(i) an identification of the location within the at least one workflow within which the data object is created;
(ii) an approval state of the data object;
(iii) an identification of the proprietary expert software solution which created the data object; and
(iv) an identification of the user.

8. The system of claim 1, wherein the proprietary expert software solution creates a further data object to be stored within the data module, the further data object being an updated data object of a previous data object, the previous data object also being retained within the data store.

9. The system of claim 1, wherein the management module controls the accessibility of each user to each processing step within the at least one workflow based upon completion of previous dependent steps within that workflow.

10. The system of claim 1, wherein a plurality of proprietary expert software solutions are able to process the data objects, each proprietary expert software solution being an application program used within the mining operation to achieve a specific outcome.

11. The system of claim 1, wherein the management module communicates a notification message to the user to notify the user that the user is able to access one or more processing steps within the at least one workflow.

12. The system of claim 1, wherein the at least one user operates a computing device having an execution manager executing thereon, the execution manager being in communication with the management module in order to obtain one or more data objects from the data store, under control of the management module, the execution manager controlling the users interaction with the proprietary expert software solution, as configured by the management module in the at least one workflow.

13. A method of integrated mine planning in a mining operation, the method including the steps of:
(i) providing a workflow having a series of interdependent processing steps representative of planning steps for a mine plan;
(ii) interactively authorizing a user to access a processing step within the workflow;
(iii) allowing the user access to a data object stored within a data module;
(iv) processing the data object using a proprietary expert software solution to produce a further data object; and
(v) allowing the user to store the further data object within the data module.

14. The method of claim 13, wherein the user is only authorized to access the processing step in the workflow in step (ii) if previous processing steps within the workflow have been completed.

15. The method of claim 13, wherein the further data object is stored to the data module in association with metadata.
